(19) United States
(12) Patent Application Publication
(10) Pub. No.: US 2012/0097742 A1
(43) Pub. Date: Apr. 26, 2012

(54) CARD READER MODULE

(75) Inventor: Gary Kung, Santa Ana, CA (US)

(73) Assignee: I O INTERCONNECT, LTD., Santa Ana, CA (US)

(21) Appl. No.: 13/099,357

(22) Filed: May 3, 2011

Related U.S. Application Data
(60) Provisional application No. 61/406,008, filed on Oct. 22, 2010.

(51) Int. Cl. G06K 7/01

(52) U.S. Cl. 235/441

(57) ABSTRACT

A card reader module includes a substrate, an insulating body, a housing, a plurality of pins, and a control chip. The housing covers the insulating body and the substrate. The pins are connected to the substrate near the front side of the housing and fixed on the insulating body. The control chip is disposed within the housing and mounted on the substrate near the rear side of the housing. By the above structure, the size of the card reader module can be reduced.

### CROSS-REFERENCE TO RELATED APPLICATIONS

This application claims the benefit of U.S. Provisional Application No. 61/406,008, filed on Oct. 22, 2010, the contents of which are incorporated herein for reference.

### BACKGROUND OF THE INVENTION

1. Field of the Invention

The invention relates to a card reader module, and in particular, to a card reader module having a housing, and a control chip within the housing.

2. Description of the Related Art

FIG. 1 shows a conventional card reader module 1. The card reader module 1 is installed on a motherboard B1 of a computer (not shown). The card reader module 1 includes a housing 10, a printed circuit board (PCB) 20, a plurality of pins 30, a control chip 40 and a plug 50. The housing 10 is fixed on the PCB 20. The housing 10 has a front side 11 and a rear side 12. The front side 11 has an inserting opening 13. The control chip 40 is electrically connected to the pins 30 and the plug 50. A flash card A1 can be inserted into the inserting opening 13 and connected to the pins 30.

Because the pins 30 are connected to the PCB 20 within the housing 10 near the rear side 12 and the flash card A1 is inserted into the housing 10 from the front side 11, there is no extra space in the housing 10 for the control chip 40. Therefore, the control chip 40 must be mounted on the PCB 20 outside of the housing 10, increasing the size of the PCB 20.

The plug 50 is mounted on the PCB 20 outside of the housing 10. The plug 50 is connected to a receptacle B1 of the motherboard B2, and the card reader module 1 can be connected to the motherboard B1. Therefore, the size of the PCB 20 is increased because the plug 50 is mounted on the PCB 20.

In view of the above, the size of the card reader module 1 cannot be further reduced because of the size of the PCB 20. Thus, the conventional card reader module 1 is too large for a miniaturized computer.

### BRIEF SUMMARY OF THE INVENTION

Accordingly, the invention provides a card reader module for a flash card. The card reader module is installed on a motherboard of a computer. The card reader module includes a substrate, an insulating body, a housing, a plurality of pins, and a control chip. The housing covers the insulating body and the substrate. The housing has a front side and a rear side. The pins are connected to the substrate near the front side of the housing and fixed on the insulating body. The control chip is disposed within the housing and mounted on the substrate near the rear side of the housing.

Accordingly, because the pins are connected to the substrate near the front side of the housing, the control chip can be disposed between the housing and the substrate. The size of the substrate can be reduced, and the size of the card reader module can be further reduced.

### BRIEF DESCRIPTION OF THE DRAWINGS

The invention can be more fully understood by reading the subsequent detailed description and examples with references made to the accompanying drawings, wherein:

FIG. 1 is a schematic view illustrating a card reader module, a motherboard, and a flash card of prior art;

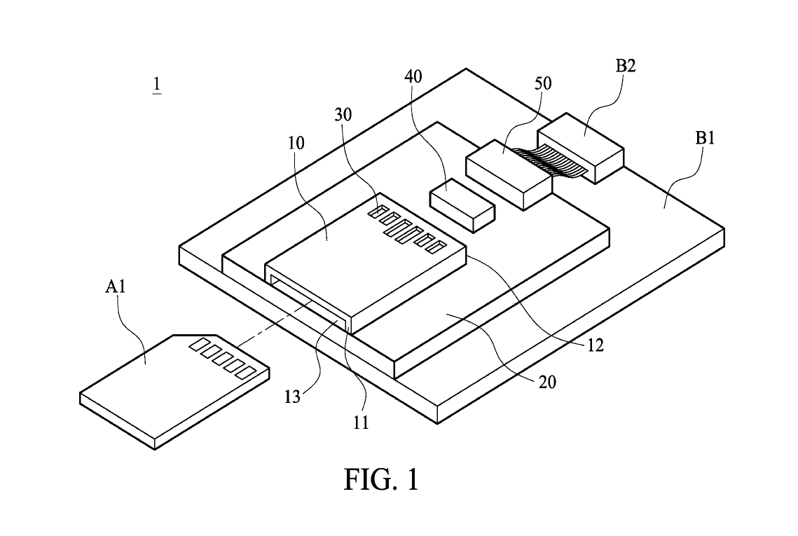

FIG. 2 is a perspective view illustrating a first embodiment of a card reader module of the present invention;

FIG. 3 is an exploded view illustrating the first embodiment of the card reader module;

FIG. 4 is a partial exploded view illustrating the first embodiment of the card reader module;

FIG. 5 is a schematic view illustrating the card reader module, a motherboard, and a flash card;

FIG. 6 is a partial exploded view illustrating a second embodiment of the card reader module; and

FIG. 7 is a perspective view illustrating a second embodiment of the card reader module.

### DETAILED DESCRIPTION OF THE INVENTION

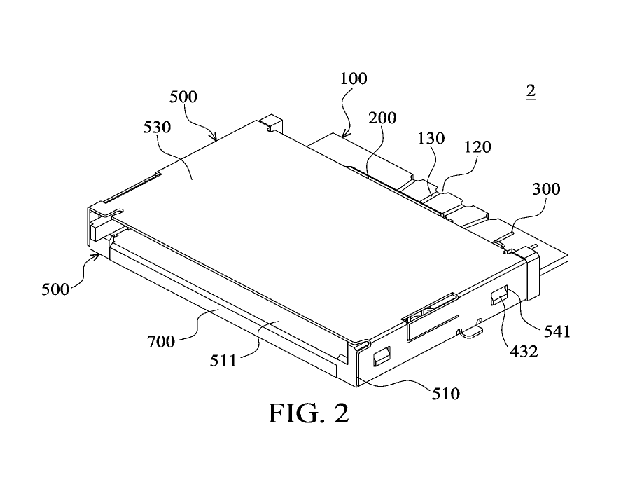

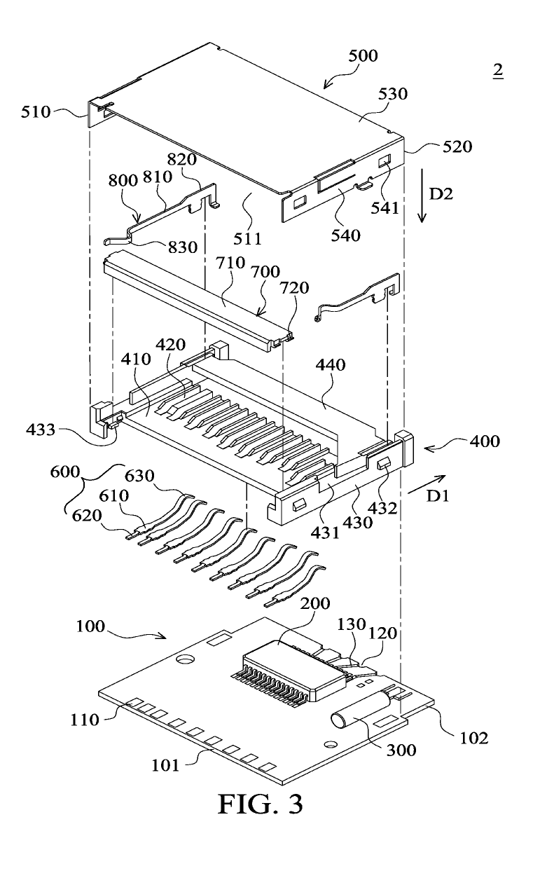

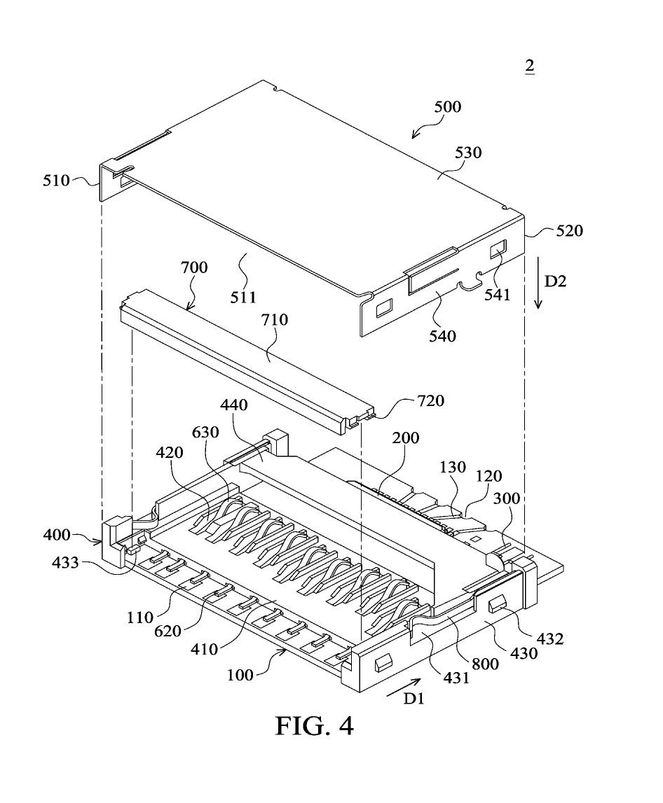

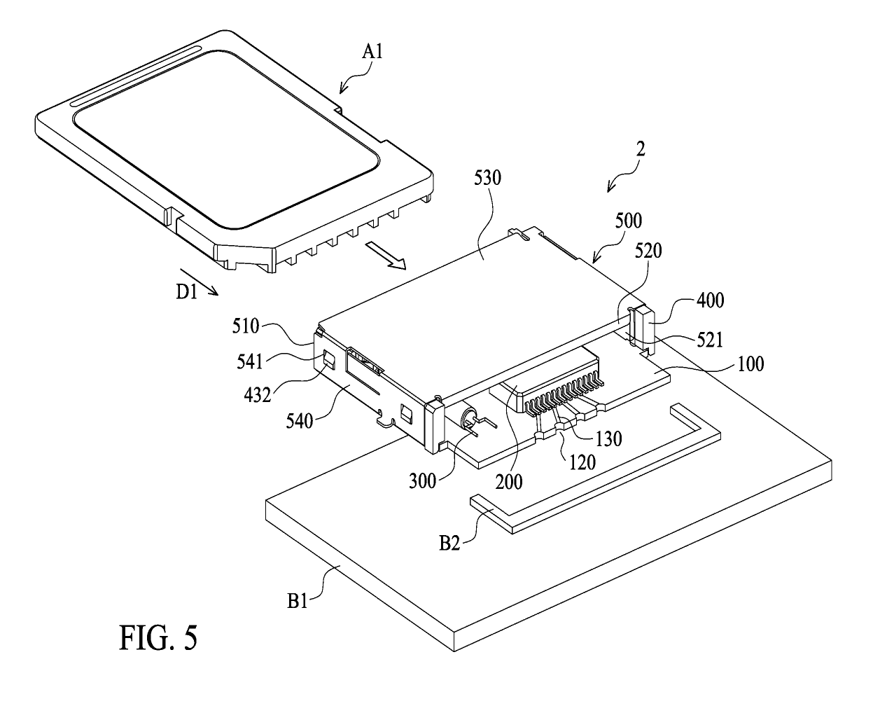

Please refer to FIGS. 2 to 4. FIG. 2 is a perspective view illustrating a first embodiment of a card reader module 2 of the present invention. FIG. 3 is an exploded view illustrating the first embodiment of the card reader module 2. FIG. 4 is a partial exploded view illustrating the first embodiment of the card reader module 2. The card reader module 2 is installed on a motherboard B1 (shown in FIG. 5) of a computer (not shown).

The card reader module 2 includes a substrate 100, a control chip 200, an electronic component 300, an insulating body 400, a housing 500, a plurality of pins 600, a cover element 700, and two anchor elements 800.

The substrate 100 can be a printed circuit board. The substrate 100 has a plurality of pads 110, a plurality of connecting portions 120, and a plurality of connecting pins 130. The pads 110 are disposed at a front edge 101 of the substrate 100. The connecting portion 120 can be a groove disposed on a rear edge 102 of the substrate 100. The connecting pins 130 are connected to the control chip 200 and disposed in the connecting portions 120, respectively.

The control chip 200 and the electronic component 300 are mounted on the substrate 100. The control chip 200 controls a flash card A1 (shown in FIG. 5) when the flash card A1 is inserted into the card reader module 2. The electronic component 300 is a passive component, such as a resistor or a capacitor, or an oscillator.

The insulating body 400 is disposed on the substrate 100. The insulating body 400 includes a retaining portion 410, a plurality of terminal holes 420, two support portions 430, and a frame portion 440. The retaining portion 410 is located near the front edge 101 of the substrate 100. The terminal holes 420 are disposed on the retaining portion 410.

The support portions 430 are extended along an inserting direction D1. The support portions 430 are disposed on opposite sides of the retaining portion 410, and the opposite sides of the substrate 100 are covered by the support portions 430. Namely, the substrate 100 is located between the support portions 430, and the substrate 100 is under the retaining portion 410. The control chip 200 and the electronic component 300 are located between the support portions 430. Each of the support portions 430 has a receiving groove 431, a locking part 432, and a latching part 433. The latching part 433 is located near the front side 510.

The frame portion 440 is connected to both of the support portions 430, and is separated from the substrate 100 by a distance. The control chip 200 and the electronic component 300 can be located between the frame portion 440 and the substrate 100. The strength of the card reader module 2 can be improved by the frame portion 440.

The housing 500 is made of a metal plate. The housing 500 is substantially in a U shape. The housing 500 has a front side 510 and a rear side 520. The front side 510 is opposite to the rear side 520. The front side 510 has an inserting opening 511. The pads 110 are located near the front side 510 and the inserting opening 511. The control chip 200 and the electronic component 300 are located near the rear side 520 and within the housing 500.

The housing 500 includes a cover portion 530 and two side walls 540. The side walls 540 are extended from the cover portion 530 along an extension direction D2. The extension direction D2 is perpendicular to the inserting direction D1. The cover portion 530 and the side walls 540 of the housing 500 cover the substrate 100 and the insulating body 400. Each of the side walls 540 has a locking hole 541. The locking part 432 corresponds to the locking hole 541. When the housing 500 is disposed on the insulating body 400, the locking part 432 is held in the locking hole 541. Therefore, the support portions 430 can be clamped by the side walls 540, respectively.

The pins 600 are substantially extended toward the rear side 520 of the housing 500 along the inserting direction D1. Each of the pins 600 has a fixing portion 610, a welding portion 620, and a contact portion 630. The fixing portion 610 and the welding portion 620 are located near the front side 510 and the inserting opening 511. The fixing portion 610 is connected to the welding portion 620 and the contact portion 630. The fixing portion 610 is fixed by the insulating body 400.

In this embodiment, the fixing portion 610 is embedded in the retaining portion 410 by injection molding. Therefore, the pins 600 of this embodiment can be welded on the substrate 100 more easily and more accurately. The welding portion 620 is welded on the pads 110 of the substrate 100 near the front side 510 and the inserting opening 511. The contact portion 630 is movably received in the terminal holes 420, respectively. The contact portion 630 is connected to the flash card A1, when the flash card A1 is inserted into the card reader module 2. By the above structure, the pins 600 of the embodiment can be tightly fixed in the card reader module 2.

Moreover, because the welding portion 620 is welded on the substrate 100 near the front side 510 and the pins 600 are substantially extended toward the rear side 520, an extra space between the substrate 100 and the housing 500 is available for the control chip 200 and the electronic component 300. Therefore, the control chip 200 and the electronic component 300 can be disposed in the housing 500 and the insulating body 400, and the size of the substrate 100 can be reduced.

Please refer to FIG. 4, wherein the cover element 700 is disposed on the support portions 430. The cover element 700 includes a cover body 710 and two hook parks 720. The hook parks 720 are disposed on both ends of the cover body 710. When the cover element 700 is disposed on both of the support portions 430, the hook parks 720 are hooked by the blocking parts 433. Then, the cover element 700 is clamped by the support portions 430, and the welding portions 620 are covered by the cover element 700. Therefore, the welding portions 620 can be protected.

The anchor elements 800 are made of a metal plate. The anchor elements 800 are received and fixed in the receiving grooves 431, respectively. Each of the anchor elements 800 includes a flexible arm 810, a fixed part 820 and a latching part 830. The flexible arm 810 is connected to the fixed part 820 and the latching part 830. The fixed part 820 is fixed in the receiving groove 431. The flexible arm 810 and the latching part 830 are moveably received in the receiving groove 431. The latching part 830 is a bended structure. When the flash card A1 is inserted in the card reader module 2, the flexible arm 810 is bended by the flash card A1 and the latching part 830 provides an elastic force to the flash card A1. Then, the flash card A1 is clamped by the anchor elements 800.

Please refer to FIG. 5. The card reader module 2 is disposed on the motherboard B1, and the flash card A1 is inserted into the card reader module 2 from the front side 510 along the inserting direction D1. The housing 500 has a rear opening 521 at the rear side 520, and the substrate 100 is extended through the rear opening 521 along the inserting direction D1. Part of the control chip 200 and the electronic component 300 are located outside of the housing 500 and the insulating body 400. The connecting pins 130 in the connecting portions 120 are electrically connected to a receptacle B2 by surface mount technology (SMT). Therefore, the plug of the prior art is not required, and the size of the card reader module 2 of this embodiment can be reduced.

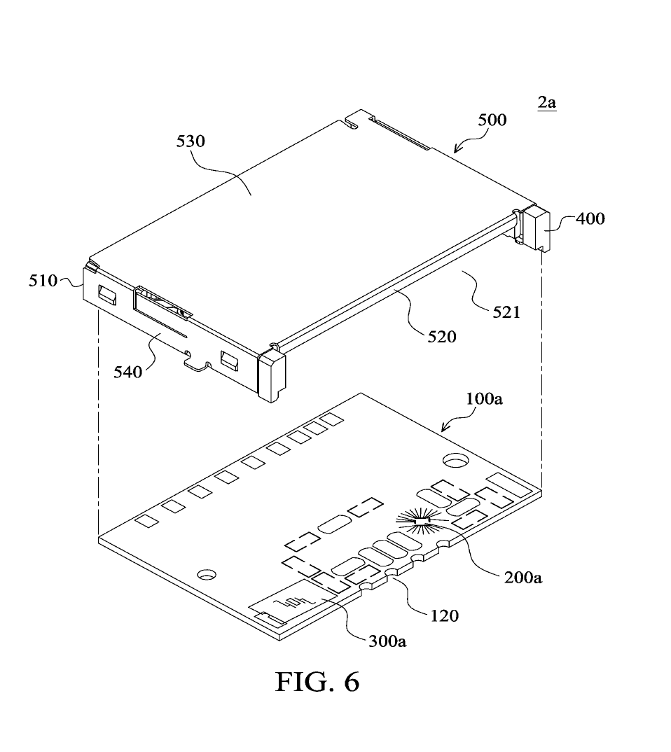

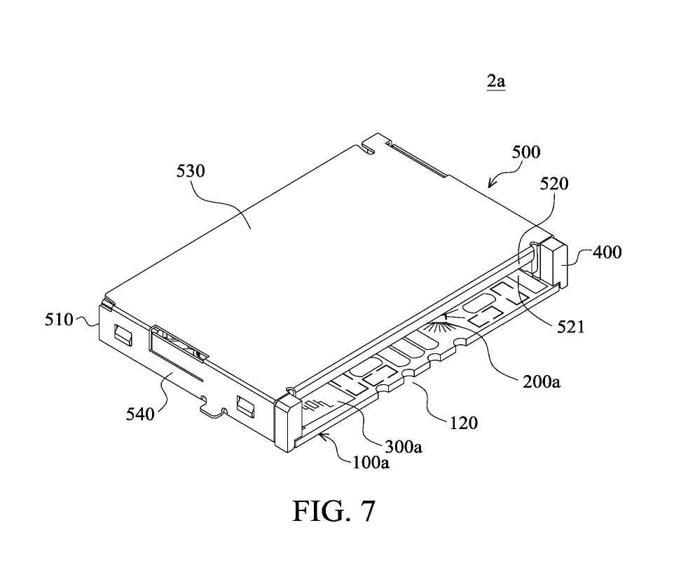

Please refer to FIGS. 6 and 7, illustrating a second embodiment of the card reader module 2. The control chip 200a and the electronic component 300a are integrated circuits made by semiconductor processes. Therefore, the size of the substrate 100a can be further reduced, and the size of the card reader module 2a can be further reduced, too. In this embodiment, the substrate 100a, the control chip 200a and the electronic component 300a are within the insulating body 400, and not on the outside thereof. In another embodiment, the substrate 100a, the control chip 200a and the electronic component 300a are within the housing 500, and not on the outside thereof.

In conclusion, because the pins are connected to the substrate near the front side of the housing, and extended toward the rear side of the housing, the control chip and the electronic component can be disposed between the housing and the substrate. The size of the substrate can be reduced, and the size of the card reader module can be further reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A card reader module for a flash card, comprising:
a substrate;
an insulating body disposed on the substrate;
a housing, covering the insulating body and the substrate, having a front side and a rear side;
a plurality of pins connected to the substrate near the front side of the housing and disposed on the insulating body; and
a control chip disposed within the housing and mounted on the substrate near the rear side of the housing,
wherein the flash card is inserted into the housing from the front side.

2. The card reader module as claimed in claim 1, wherein each of the pins has a fixing portion embedded in the insulating body, a welding portion fixed on the substrate near the front side, and a contact portion located near the control chip and the rear side.

3. The card reader module as claimed in claim 2, wherein the insulating body comprises a plurality of pin holes and a retaining portion, the fixing portion is embedded in the retaining portion, and the contact portions are received in the pin holes, respectively.

4. The card reader module as claimed in claim 3, further comprising a cover element disposed on the insulating body, wherein the welding portion is covered by the cover element.

5. The card reader module as claimed in claim 1, wherein the insulating body comprises a retaining portion and two support portions disposed on the retaining portion, and the pins are embedded in the retaining portion.

6. The card reader module as claimed in claim 5, wherein the substrate is disposed between the support portions and the retaining portion.

7. The card reader module as claimed in claim 5, wherein the housing comprises a cover portion and two side walls, the side walls is extended form the cover portion, and the support portions are clamped by the side walls.

8. The card reader module as claimed in claim 5, wherein the control chip is disposed between the support portions.

9. The card reader module as claimed in claim 5, wherein the insulating body comprises a frame portion connected to both of the support portions, and the control chip is disposed between the frame portion and the substrate.

10. The card reader module as claimed in claim 5, further comprising a plurality of anchor elements disposed on the support portions, respectively, wherein the flash card is clamped by the anchor elements.

11. The card reader module as claimed in claim 1, wherein the substrate has a plurality of connecting portions disposed at an edge of the substrate, and a plurality of connecting pins disposed in the connecting portions and electrically connected to the control chip.
